(19) United States
(12) Patent Application Publication
(10) Pub. No.: US 2023/0322390 A1
(43) Pub. Date: Oct. 12, 2023

(54) INTEGRATED PARTITION WALL ARRANGEMENT HAVING A CABIN ATTENDANT SEAT, CARRIER STRUCTURE AND METHODS FOR PRODUCING AND DESIGNING A CARRIER STRUCTURE OR A PARTITION WALL ARRANGEMENT

(71) Applicant: Diehl Aviation Hamburg GmbH, Hamburg (DE)

(72) Inventors: Claudius Wahl, Norderstedt (DE); Michael Quadbeck, Hamburg (DE); Andreas Schmidt, Buchholz (DE); Roberto Giraldo, Hamburg (DE)

(21) Appl. No.: 18/180,177

(22) Filed: Mar. 8, 2023

(30) Foreign Application Priority Data
Apr. 7, 2022 (DE) 10 2022 108 421.3

(51) Int. Cl. B64D 11/06; B64C 1/10

(52) U.S. Cl. CPC B64D 11/0691; B64C 1/10; B64D 11/0698

(57) ABSTRACT

A partition wall arrangement for a cabin of a passenger aircraft includes a partition wall, a seat arrangement secured to the partition wall in an assembled state and containing a carrier structure, and at least one cabin attendant seat. The carrier structure contains a mechanically load-bearing wall structure for the partition wall, a mechanically load-bearing seat structure for the seat arrangement, and at least one fastening device in order to secure the wall structure and the seat structure to each other in the assembled state. In a method for producing the carrier structure or the partition wall arrangement, the wall structure or at least a main component thereof is produced as a milled component by milling out a solid material plate. In a design method, the entire carrier structure is subjected in the assembled state to a load path optimization.

### CROSS-REFERENCE TO RELATED APPLICATION

This application claims the priority, under 35 U.S.C. § 119, of German Patent Application DE 10 2022 108 421.3, filed Apr. 7, 2022; the prior application is herewith incorporated by reference in its entirety.

### FIELD AND BACKGROUND OF THE INVENTION

The invention relates to a partition wall arrangement for a cabin of a passenger aircraft. The partition wall arrangement contains a partition wall and a seat arrangement. The seat arrangement is secured to the partition wall in an assembled state. The seat arrangement includes at least one seat for cabin crew (CA: Cabin Attendant), a so-called CAS (Cabin Attendant Seat). In an assembled state, the seat arrangement is secured to the partition wall.

European Patent EP 3 173 331 B1, corresponding to U.S. Pat. No. 10,450,067, discloses an aircraft structural component which includes the following: a substantially planar core panel having a grid frame structure of load-bearing grid frame rods; and a covering panel which is mounted on a front face of the core panel, wherein the covering panel includes the following: a protective cover with an outer shape which corresponds to the outer shape of the core panel, wherein the protective cover contains at least one cut-out opening; and at least one fiber panel which is mounted on the protective cover and which covers at least one cut-out opening, wherein the at least one fiber panel is inserted between the core panel and the protective cover.

The aircraft structural component in the form of a partition element (partition: dividing wall) may contain a securing plate which is configured to secure functional elements to the partition element. The securing plate may, for example, be adapted in order to mount a wall-mounted flight attendant seat (CAS bench, Cabin Attendant Seat, Flight Attendant Seat) having a pivotable seat on the partition element.

### SUMMARY OF THE INVENTION

It is accordingly an object of the invention to provide an integrated partition wall arrangement having a cabin attendant seat, a carrier structure and methods for producing and designing a carrier structure or a partition wall arrangement, which improve and overcome the hereinafore-mentioned disadvantages of the heretofore-known devices and methods of this general type.

With the foregoing and other objects in view there is provided, in accordance with the invention, a carrier structure for a partition wall arrangement for a cabin of a passenger aircraft, the partition wall arrangement including a partition wall and a seat arrangement secured to the partition wall in an assembled state and having at least one cabin attendant seat, the carrier structure comprising a mechanically load-bearing wall structure for the partition wall, a mechanically load-bearing seat structure for the seat arrangement, and at least one fastening device conventionally provided and configured to secure the wall structure and the seat structure to each other in the assembled state in conventional manner.

Preferred or advantageous embodiments of the invention and other invention categories will be appreciated from the additional claims, the following description and the appended figures.

The carrier structure is a carrier structure for a partition wall arrangement as described above, for a cabin of a passenger aircraft. The cabin includes in particular a passenger region and a crew region. The passenger region substantially contains the passenger seats, the crew region contains seats for the cabin attendants and in particular a galley, a washroom, an entry/exit region for passengers, etcetera. The crew region is in particular an area in the rear portion which is located counter to the flight direction (“AFT,” for example, at “door No. 4” of the aircraft) of a passenger aircraft. Alternatively, the partition wall arrangement (CAS partition) may also be installed at the front in the aircraft (“FWD,” for example, at “door No. 1”). In this instance, the seat arrangement (CAS) is then fitted to the partition (partition wall) in the flight direction, that is to say, facing “forwards.” The crew region is then disposed when viewed in the flight direction in front of the passenger region. Therefore, the partition wall arrangement contains as described above a partition wall and a seat arrangement which is secured to the partition wall in an assembled state. The partition wall separates in particular the crew region from the passenger region and extends transversely relative to the longitudinal direction of the aircraft. The seat arrangement contains at least one cabin attendant seat.

The carrier structure contains a wall structure for the partition wall or of the partition wall. This is intended to be understood in such a manner that, with an existing complete partition wall, the wall structure is part of the partition wall. The term “mechanically load-bearing” is intended to be understood in such a manner that the wall structure at least for the most part, that is to say, to an extent greater than half, in particular at least 75%, at least 80%, at least 90% or completely, produces the mechanical load-bearing capacity of the wall structure. In particular, for example, the wall structure is a carrier frame of the partition wall which is supplemented only by a mechanically non-load-bearing trim, decorative components, a film coating, coat of paint, attachments, etcetera, which make no relevant contribution to the mechanical load-bearing capacity of the partition wall. The wall structure is thus the only component of the partition wall which is intended to be taken into account when considering the strength of the partition wall.

The carrier structure further contains a mechanically load-bearing seat structure for the or of the seat arrangement. The terms “for the” and “mechanically load-bearing” are intended in this instance to be understood with respect to the seat arrangement analogously as above with the wall structure.

The carrier structure contains at least one fastening device. The fastening device is conventionally provided and configured to secure the wall structure and the seat structure to each other in the assembled state in conventional manner. The term “conventional” means that the fastening device is structurally adapted to specific or specific types of wall/seat structures, and is configured for use at that location; for example, it is configured for the geometry requirements determined thereby, etcetera. In other words, relevant wall/seat structures as known with respect to their geometry, size, material properties, etcetera, are required.

In addition to the carrier structure, the seat structure still contains in particular only additional components for the or of the seat arrangement and/or partition wall which do not contribute or contribute only in an insignificant manner to the mechanical stability of the partition wall arrangement, such as a backrest, a headrest, a seatbelt, connection locations/pivot apparatus for a folding seat, fastenings for items of equipment, storage compartments, signs, etcetera.

The carrier structure thus includes a wall structure, seat arrangement and fastening device, wherein in the assembled state an inherently mechanically strong carrier structure is produced, wherein the wall structure and seat structure are actually secured to each other using the fastening device.

In particular in the carrier structure, therefore, the wall structure and the seat structure are actually secured to each other using the fastening device. The fact that the fastening devices are “provided and configured” refers in particular to a strength analysis or a concept or design process for the carrier structure, in particular a virtual modelling of all the components, wherein the wall structure and seat structure are secured to each other using the fastening devices virtually in a virtual assembled state.

The partition wall arrangement is thus configured in particular for conventional assembly in a conventional cabin or a conventional aircraft.

The partition wall thus includes the carrier structure and where applicable additional components which are not mechanically load-bearing or are mechanically load-bearing only to an insignificant extent for the partition wall. The additional components are then omitted, for example, in a design process or during a strength consideration of the carrier structure, for example, not virtually modelled, since they are insignificant to the results.

The seat arrangement is configured for one or more persons, in particular cabin attendants. A plurality of seats may in this instance have a single two-seat or multiple-seat structure in an integrated state or also have individual components for individual persons or individual seats which, for example, in a state beside each other—are mounted individually on the partition wall. For dual or multiple seats, again in particular foldable individual seats or a foldable bench type seat for several people is conceivable. However, the above-mentioned strength consideration does not always take into account the entire seat structure.

The wall structure may also in this instance be a single component or include a plurality of individual components; the above statements relating to the seat structure apply accordingly.

The seat structure is in particular a lower portion of the seat arrangement, that is to say, a portion which faces a floor of the passenger cabin in the fitted state and which extends only as far as the height of a seat face connection or only as far as the height of an upper third of a backrest or as far as the upper edge of the backrest or extends over the entire height of the seat arrangement.

The fastening devices may in particular include specific individual measures, such as, for example, a screw or rivet or an adhesive or may include a plurality of such individual measures. In this instance, however, a fastening device is also intended to be understood to be a spatial region, such as, for example, a welding spot or other materially engaging or positive-locking connection between the seat and carrier structure. In particular, an integral connection—which is generic or also brought about by adhesive—between or configuration of the wall structure and seat structure is also included by the term “fastening device.” The fastening device becomes simplified in this instance to virtually a “zero device” in the form of the integral configuration of the wall structure and seat structure, in particular thus to a notional separation face between both structures. Respective combinations of the above-mentioned variants can also be understood to be fastening devices in the present sense.

According to the invention, the advantage is afforded that the entire carrier structure forms a unit which can be subjected to a design process, a strength analysis, an interactive design process, etc., and designed so that, as a result of the synergistic cooperation of the elements wall structure, seat structure and fastening device, a unit which is intended on the whole to be optimized or considered is produced.

Other procedures take each of the elements into account individually, but do not take into account their synergy when actually secured to each other. With respect to such solutions, there are achieved according to the invention synergy effects which on the whole lead to a saving of material, saving of weight, increase in strength, etcetera, which cannot be achieved by taking into account the wall structure and seat structure and fastening device individually.

As a result, in particular an integrated arrangement including the partition wall (also “partition”) and seat arrangement (CAS) is produced which is therefore also referred to as an “integrated CAS partition wall” or “iCAS partition.”

The wall structure and seat structure and fastening device therefore form together as a result of synergistic cooperation a generally mechanical load-bearing carrier structure of the partition wall arrangement 20, wherein in particular mechanical loads on the seat arrangement are also received by the wall structure and mechanical loads on the partition wall are also received by the seat structure.

In a preferred embodiment, all the components of the carrier structure, that is to say, wall structure, seat structure and fastening device, are configured in a synergistically mutually complementary manner in the assembled state with regard to a common technical flight strength consideration. This also relates in particular, as explained above, to a virtual carrier structure in the virtual assembled state. Such strength considerations are in particular load tests, a load path optimization the technical design variation of material strengths, materials, geometries on the elements seat structure and/or wall structure, in particular the rib structure thereof, as will be explained in greater detail below.

According to this embodiment, there is thus explicitly carried out a mutual consideration of all the components of the carrier structure, in particular the entire seat arrangement and/or the entire partition wall during a design process of the elements. As a result, all the components of the carrier structure are then adapted to each other in a load-path-optimized manner, with regard to the mutual securing thereof in the assembled state using the fastening device.

The statements relate in particular to a conventional flight-technical 16 G crash test of the FAA (U.S. Federal Aviation Administration for aircraft seats) which also has to be passed for the present seat arrangement in order to obtain a so-called “16 G seat.” In particular, a “16 G iCAS partition” which meets these requirements is thus obtained.

In a preferred embodiment, a specific conventional partition wall is taken as a basis. This wall has an extent plane which corresponds to the wall plane thereof. That is to say, the partition wall as a planar structure extends in a planar manner in or along this extent plane. The wall structure contains a wall face and ribs which extend along this extent plane. The ribs are securely connected to the wall face. The ribs extend transversely relative to the extent direction and away from the wall face, thus extend themselves transversely relative to the extent plane. In other words, the ribs thus protrude transversely, in particular perpendicularly, from the extent plane and consequently form mechanically particularly stable reinforcement ribs for the wall face. In particular, the ribs are configured integrally with the wall face. In particular, the ribs are located at the side of the wall face facing the seat arrangement when the carrier structure or partition wall arrangement is mounted conventionally in the passenger aircraft. In particular, the wall structure includes exclusively the wall face and the ribs. The ribs consequently have in particular an extent which is optimized in terms of the load path and which is located taking into account the entire carrier structure, as explained above. In particular, this embodiment enables particularly material-saving and consequently lightweight partition walls. In other words, the ribs follow the load paths which have been established in the carrier structure theoretically/during tests/by using simulation and then physically model them.

In a preferred embodiment, the wall structure is constructed in an integral or one-piece manner. Alternatively or additionally, the seat structure is configured in an integral or one-piece manner. Consequently, particularly simple and, on the other hand, mechanically stable wall structures and/or seat structures are produced.

In a preferred embodiment, at least a portion of the wall structure is configured in an integral manner together with at least a portion of the seat structure. As explained above, no specific or discrete fastening device are required at that location or they are simplified for the integral connection of both elements. As a result of a complete or extensive, that is to say, integral connection of both elements seat structure and carrier structure (including fastening device), there is produced a particularly significant synergy effect described above since forces between the elements are transferred in a particularly effective and extensive manner.

In a preferred variant of this embodiment, the entire carrier structure is configured in an integral manner. In particular, no specific fastening elements are then required, they are all generic to form a respective materially engaging or integral connection of the elements seat structure and carrier structure. Consequently, a particularly simple and stable carrier structure is produced.

In a preferred embodiment, the wall structure is a metal component or the wall structure contains a metal component which forms at least a main component of the wall structure. A “main component” is in this instance and below accordingly intended to be understood as above to mean that the metal component constitutes a proportion greater than half, in particular at least 75%, at least 80%, at least 90% or completely of the volume of the wall structure. Alternatively or additionally, the seat structure is a metal component or contains this metal component at least as a main component. The same statements as in relation to the wall structure apply accordingly. The metal is in particular an aluminum material. Particularly light and stable wall structures and/or seat structures are thereby produced.

In a preferred embodiment, the wall structure is a milled component or the wall structure contains such a milled component at least as a main component. Alternatively or additionally, this also applies to the seat structure. The milled component is in particular a metal milled component. The milled component is in particular individually produced according to the above-mentioned synergetic strength consideration/load path optimization and corresponding local material reinforcements/removals, etcetera. In particular, the milled component is produced with a production method by using milling from a solid material, as will be explained again below. Consequently, particularly widely varied wall structures and seat structures can be produced and load-path-optimized components can be implemented in a particularly simple manner.

In a preferred embodiment, the seat structure includes a plurality of components in the form of commercially available mass-produced goods. Alternatively, the seat structure contains at least one or more such components as a main component. Such a component is, for example, a so-called “standard profile.” Therefore, the seat structure is in other words constructed exclusively or primarily from mass-produced goods. Such components are in particular components which are not produced individually for the seat structure. The components are simply adapted to the seat structure, for example, cut to length, provided with connection holes, chamfered or otherwise finished starting from the standard shape thereof with comparatively only little complexity in comparison with an individual manufacture or individual production. Such a standard profile is in particular a square tube. According to this embodiment, particularly cost-effective seat structures are produced.

In a preferred embodiment, the carrier structure contains at least 20 fastening devices in the form of individual means. An individual device is in this instance an individual specific element, such as, for example, a screw, rivet, an adhesive structure, a weld spot, etcetera. In particular, it is at least 30, at least 40, at least 50 or at least 60 individual devices. Consequently, also using individual devices which are located comparatively close to each other, a result which corresponds to a planar materially engaging connection can also be achieved.

In a preferred embodiment, the seat structure is a basic structure of the seat arrangement which is constructed only to receive at least one additional component of the seat arrangement. Another component is, for example, a seat face which is in particular foldable, or a portion thereof, a backrest or a portion thereof, a storage compartment or a portion thereof or a headrest or a portion thereof. The foldable seat face contains in particular a folding apparatus, for example, a pivoting or carrier cross-beam.

In particular, the seat structure does not contain any headrest and/or belt system of the seat arrangement. The basic structure is in particular a frame structure. The basic structure is in particular configured to exclusively carry the components; that is to say, the components are not directly supported or secured on the wall structure, but instead this takes place exclusively indirectly through the seat structure. There is thus still a degree of freedom to combine the carrier structure depending on requirements with changing additional components in order to form different seat arrangements, wherein the carrier structure as described above is always configured in an identical load-path-optimized manner.

With the objects of the invention in view, there is also provided a partition wall arrangement for a cabin of a passenger aircraft, the partition wall arrangement comprising a partition wall and a seat arrangement secured to the partition wall and having at least one cabin attendant seat, the partition wall arrangement having a carrier structure according the invention, the partition wall containing the wall structure and the seat arrangement containing the seat structure, and the seat structure and consequently the seat arrangement being secured to the wall structure and consequently the partition wall by at least one fastening device.

The partition wall arrangement and at least a portion of the possible embodiments thereof and the respective advantages have accordingly already been explained in connection with the carrier structure according to the invention.

With the objects of the invention in view, there is furthermore provided a method for producing the carrier structure according to the invention or the partition wall arrangement according to the invention. In this instance, a carrier structure in the embodiment described above with respect to the wall structure/the main component thereof in the form of a milled component is taken as a basis. According to the method, the wall structure or at least a main component thereof is produced as a milled component by milling out a solid material plate. The invention consequently also relates to a carrier structure which is produced according to this method. The solid material plate is in particular a plate which extends over the above-mentioned extent plane over the entire partition wall or at least a main portion thereof (in this instance, “main portion” refers in the sense of “main component” above to the surface of the partition wall along the extent plane).

The method, at least some of the possible embodiments thereof and the respective advantages have accordingly already been explained in connection with the carrier structure according to the invention and the partition wall arrangement.

In a preferred embodiment of the method, in connection with the above-mentioned integral embodiment, at least a portion of the seat structure and wall structure, at least a portion of the wall structure and at least a portion of the seat structure are configured integrally with each other in that they are produced as an integral milled component by milling out the solid material plate. The integral nature can thus be produced or implemented in a particularly easy manner.

With the objects of the invention in view, there is concomitantly provided a design method for a carrier structure according to the invention or a partition wall arrangement according to the invention. During the design method, the entire carrier structure is subjected in the assembled state to a load path optimization. In particular, this is carried out in an iterative manner, in particular by reconstruction of the carrier structure, material reinforcements, material removals, material selection at specific locations, etcetera, in conventional manner. In particular, the design method is carried out in a purely virtual manner or at least partially carried out virtually. In particular, therefore, this involves a virtual carrier structure or partition wall arrangement as an object of the design method, as described above.

The method and at least a portion of the possible embodiments thereof and the respective advantages have accordingly already been explained in connection with the carrier structure according to the invention and the partition wall arrangement.

The invention is based on the following recognitions, observations or considerations and further has the following preferred embodiments. These embodiments are in this instance also sometimes referred to for the sake of simplicity as “the invention.” The embodiments may in this instance also contain portions or combinations of the above-mentioned embodiments or correspond to them and/or where applicable also include embodiments which have not previously been mentioned.

From practice, it is known to combine a CRP partition (partition wall, sandwich construction) of a first manufacturer with seat(s) (CAS) as an alien product of a second manufacturer as an attachment to a partition wall arrangement.

According to the invention, there are in contrast in particular three different concepts A to C which can be summarized as follows:

Concept A: The wall structure includes a milled component which is produced by milling out an aluminum solid material plate with the thickness 30 mm. The seat structure is a CAS frame (basic structure) including a plurality of milled components.

Concept B: According to concept A, the wall structure is also a milled component from the same solid material plate. The seat structure in the form of a CAS frame (basic structure) includes in contrast a plurality of standard profiles (conventional mass-produced goods).

Concept C: A single milled component produced from an aluminum solid material plate with the thickness 70 mm includes the wall structure and the CAS frame (basic structure of the seat structure) which is produced by milling the same plate integrally in one piece from the same raw material. Consequently, the carrier structure is produced as a completely integral milled component.

In detail:

The 16 G partition known from practice is produced as a conventional CRP sandwich construction type with locally introduced metal reinforcements and with or without an integrated “stretcher flap” (wall portion) which can be pulled out. It contains an upper and lower aircraft fastening (for securing the partition wall in the aircraft to the primary structure thereof) and screwing locations for the CAS and for emergency equipment. The CAS sub-assembly originates from a different manufacturer from the partition and has in particular a backrest and a foldable seat face (bench for 2 persons or single seat: “single CAS”) and a headrest with storage compartment, a belt system for one or two flight attendants and a storage compartment with a flap in the floor region. As a partition wall arrangement, there is consequently a definitively mounted partition with subsequently installed CAS.

The problem in this instance is as follows: the CAS is generally developed by an alien manufacturer for a “standard cabin interface,” that is to say, a partition wall with comparatively more rigid peripheral conditions than, for example, the CRP partition wall known from practice. The (less rigid) CRP/composite partition actually used by a partition wall manufacturer must therefore compensate for a sub-optimal CAS design by significant additional reinforcements. It is further problematic when the CAS manufacturer provides new CAS versions which are lighter but mechanically weaker than the previous embodiment. This leads in the overall system of the partition wall arrangement to a destruction of the partition during the 16 G test. A further reinforcement of the partition is then necessary.

In the known solution, the CAS has only the function of accommodating the cabin crew and emergency equipment. The CAS structure may also reinforce the partition to some degree, but only to a very small extent. The notion of the invention is in this instance to achieve improvements.

The situation known from practice can therefore be summarized as follows: the composite partition wall was designed for a suboptimal CAS, wherein the specific features of a partition monument (high level of deformation) were not taken into account. The CAS is secured to the partition wall with only a few, for example, eight screws and reinforces it only to a very small degree. The CAS loses its rigidity precisely when it is most required, that is to say, when a high partition deformation occurs.

The current cabin requirements are as follows: the partition wall divides the passenger region from the crew/attendant region. The CAS acts as a seat for the cabin crew.

The invention is based on the observation that new market requirements exist: the single-aisle family of aircraft is faced with weight problems, particularly in the rear cabin region (AFT cabin area). “Greener” environmental requirements make a higher degree of efficiency necessary. The narrow spatial relationships between the AFT complex and the partition make it difficult to maneuver trolleys.

The invention therefore takes a new approach. There is an integration of the CAS and partition with respect to mutual consideration during the design. Both monuments are load-path-optimized in order to comply with both the old and new requirements. This is achieved in that the configuration and design of the CAS are adapted in order to better conform to the partition deformation and to support it. An overall increase of rigidity in the region above the CAS is implemented in order to counteract the significant partition deformation.

According to the proposed solution, there is an integration of CAS and partition, a new material and production method for the partition for a load path optimization (milled metal plate), an interactive design optimization places material reinforcements only at locations where they are required, there is an improvement of the connection between the monuments (approximately 60 screws for the concepts A and B, ideally (since they are integral) for the concept C). This increases the overall rigidity and reduces the bending. A saving of weight and less structural space are achieved by using lighter and thinner structures. Rounded upper corners can be produced. The upper seatbelt rollers are fitted directly to the partition. There is a load-bearing lower structural portion (basic structure) of the CAS. The backrest is in particular directly fitted to the partition.

The concept A has in particular the following features:

The upper and lower aircraft fastenings are transferred unchanged from the known solution. The wall structure includes with respect to its structure an approximately 1 inch thick (30 mm) base plate made of aluminum as the base material which is milled in a load-path-optimized manner, together with a 1.6 mm thick cover plate. Both components are screwed to each other and adhesively bonded. An optionally provided stretcher flap which can be pulled out is produced in a milled manner from aluminum. The headrest includes a cushion and an integrated storage compartment. The belt system is configured as a purchased component. The seat structure contains a CAS frame including a plurality of milled aluminum components which are secured to the partition (wall structure). In the foot region, there is a storage compartment with a flap for emergency equipment. The back and seat cushions include a seat face which can be folded in; the seat face bracket is directly secured to the CAS frame. The CAS frame is a milled aluminum component with reinforcements.

According to the concept A, there is a new production process for the partition. There is a variable thickness of the metal components with respect to the previously constant thickness of carbon/glass prepregs. The rib structure follows the load path.

The CAS is no longer a stand-alone component. The backrest and seat belts are secured directly to the partition in contrast to the known construction type, in which everything belongs to the CAS. The connection between the CAS and the partition is improved by increasing the number of screws from 8 to approximately 59.

The CAS frame has the following features. Different milled components are screwed to each other. The seat face carrier is fitted directly to the frame. Additional components are fitted to the frame for the storage compartments. Local reinforcements (7 to 8 in vertical members) prevent bending. The shape and dimensions are changed in order to maximise the load-bearing capacities. The CAS bench is replaced with two individual CAS seats. Alternatively, a single CAS is provided. A perpendicular central carrier is introduced. The horizontal upper and lower portions are improved in order to maximise the load-bearing capacities.

Concept B has in particular the following features:

The features correspond to those of concept A with the following differences: the CAS frame includes a plurality of standard profiles which are secured to the partition (wall structure). Connecting angled members connect the standard profiles. The seat carrier is fitted to an additional bracket which in turn is fixed to the standard profiles. The CAS frame with reinforcements includes standard aluminum profiles.

The CAS frame thus includes standard aluminum profiles which are screwed together by using angled members. The seat bracket is fitted to the frame by using additional brackets. The profiles are covered with an additional cushion. Local reinforcements are required in order to enable the support of the folding seats.

The concept C has the following features:

The concept corresponds to the concepts A and B with the following differences: the wall structure and seat structure are in this instance in the form of an integral component. This component is produced as a milled aluminum component from an approximately 70 mm thick base plate with an aluminum construction type, screwed and adhesively bonded to a 1.6 mm cover plate. The construction type is optimized in terms of load path. The integral component has additional ribs for securing the backrests of the seat arrangement. The aluminum CAS frame with reinforcements (seat structure) is thus produced together with the partition (wall structure) in an integral manner by milling the single aluminum base plate.

With regard to the new production process for the partition, in this instance “partition webs” are therefore expanded and consequently form the CAS frame or the seat structure. The CAS frame and the partition constitute the same structure, that is to say, a uniform integral component (seat structure and wall structure). The seat bearing is again fitted to the frame using an additional bracket.

In a comparison of the three concepts, the concept C has been found to be particularly advantageous since it is on the whole in particular thinner and consequently has a higher potential for a reduction of the footprint.

On the whole, particularly the following can be determined:

The invention is based on the observation that in practice the partition wall and seat are currently present as separate components. For actual use, the seat is screwed to the partition wall by using screws. The partition wall is in this instance produced, for example, with a composite construction type from metal-reinforced honeycomb panels with pre-impregnated fiber matrix semi-finished products (prepregs). Individual separately tested CA seats (CA: cabin attendant/cabin crew seat) from other manufacturers (with respect to the manufacturer of the partition wall) with securing to the aircraft structure or to cabin monuments (for example, lavatory, storage cupboard, etcetera) have previously been required.

The invention is based on the notion of developing a new construction type for aircraft cabin partition walls in which the composite construction type is replaced with a monolithic aluminum metal construction type. The development of this construction type exploits considerable cost potential.

According to the invention, therefore, the structural components of the seat in the context of a so-called integral construction type are transferred into the structure of the partition wall. The CA seat as a separately existing product is consequently eliminated. An integral component (carrier structure or partition wall arrangement) which has the distinctive features of both previously separate products is produced.

In combination, the new construction type enables a reduction of the overall weight and the structural depth with the maximum deformation being maintained with loading. This applies to the partition wall arrangement (“′iCAS partition”) with one integrated seat and two integrated CA seats. Furthermore, a reduction of the production costs is possible.

According to the invention, an integral construction type with function integration is consequently produced. A material use is based in particular on recyclable aluminum. A low weight, low costs and rapid availability are achieved.

The proposed carrier structure or partition wall arrangement (“iCAS partition”) combines two conventional functions in one function (partition+CA seat). The main components of a CA seat (for example, headrest, backrest, folding seat, etcetera) are connected separately or in sub-assemblies to the partition and thus form an integral construction type. This also applies to the belt retention system. The partition (integrated as a carrier structure or partition wall arrangement) replaces the main structure of a conventional separate CA seat. The purchase of a separate CA seat is consequently no longer necessary.

The solution proposed in this instance is characterized by the following features (individually or in combination):
function integration of partition and CAS,
relevant saving of weight,
both single CAS and double CAS are possible,
stretcher flap available as an option,
integration of storage compartments and/or provisions for relevant equipment can be configured,
folding seat/bench type seat with belt system,
construction type made of metal,
connection by using screws and/or rivets and/or adhesives.

With regard to the assembly/integration of the partition wall arrangement in the aircraft, the use of existing interfaces is found to be advantageous.

The proposed partition wall arrangement can be provided in particular for installation at the left (LH) aircraft side or the right (RH) aircraft side.

According to the invention, a partition wall arrangement in the form of a “16 G partition,” which thus passes the above-mentioned 16 G test, is found to be particularly advantageous.

Other features which are considered as characteristic for the invention are set forth in the appended claims.

Although the invention is illustrated and described herein as embodied in an integrated partition wall arrangement having a cabin attendant seat, a carrier structure and methods for producing and designing a carrier structure or a partition wall arrangement, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, partially-sectional, side-elevational view of a partition wall arrangement which is definitively mounted in a cabin of a passenger aircraft;

FIG. 2 is an exploded, perspective view, drawn to an enlarged scale, of the partition wall arrangement of FIG. 1 according to a concept A;

FIG. 3 is a perspective view according to an alternative concept A;

FIG. 4 is a perspective view according to an alternative concept B;

FIG. 5 is a perspective view according to an alternative concept C;

FIG. 6 is a perspective view of a seat structure in the form of a CAS frame with additional components according to concept A;

FIG. 7 is a perspective view according to concept B;

FIG. 8 is a perspective view according to concept C; and

FIG. 9 is a perspective view of an alternative wall structure with a wall face and ribs.

### DETAILED DESCRIPTION OF THE INVENTION

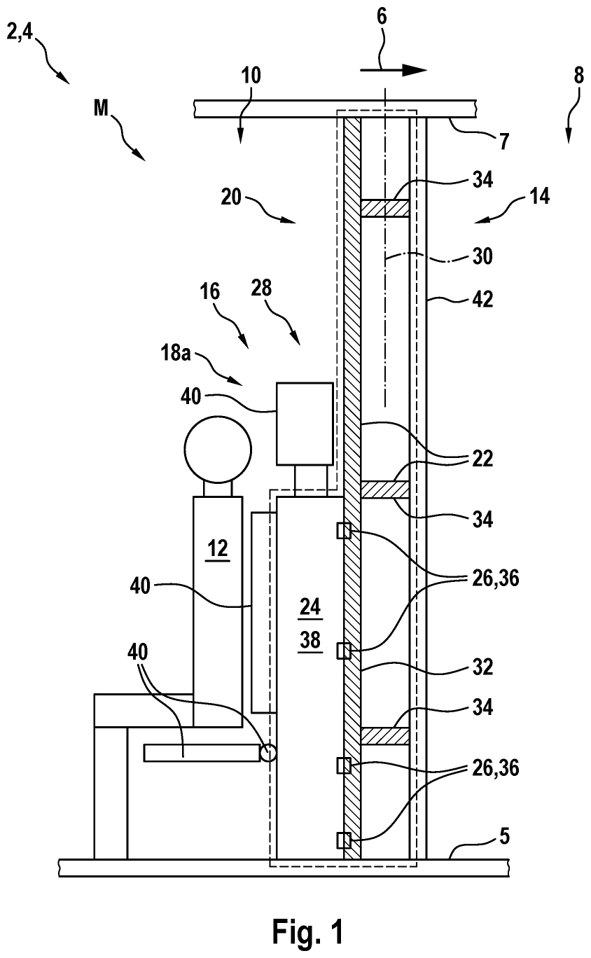

Referring now to the figures of the drawings in detail and first, particularly, to FIG. 1 thereof, there is seen a cut-out of a passenger aircraft 2, that is to say, a cut-out from a cabin 4 thereof. During flight, the aircraft moves in a flight direction 6. The cabin 4 has a floor 5 and a ceiling 7. A rear portion (AFT) of the aircraft 2 and consequently also a rear end of a passenger region 8 of the cabin 4 with a backwardly adjacent crew region 10 for cabin crew 12, in this instance a rear exit region with galley and lavatory, are illustrated. The passenger region 8 and crew region 10 are separated from each other by a partition wall 14. The partition wall 14 at the left aircraft side (LH) is illustrated in section in FIG. 1. A seat arrangement 16, in this instance in an assembled state M, is secured to the partition wall 14. The seat arrangement 16 includes in this instance two cabin crew seats 18a, b of which only the seat 18a can be seen in FIG. 1. The seat arrangement 16 and partition wall 14 together form a partition wall arrangement 20.

The partition wall 14 includes a mechanically load-bearing wall structure 22 which is illustrated with hatching in FIG. 1. The seat arrangement 16 includes a seat structure 24 which supports it mechanically. Fastening devices 26, in this instance screws, of which only four are illustrated diagrammatically in FIG. 1, are provided and configured and, in the example, also actually used in the assembled state M to secure the wall structure 22 and seat structure 24 to each other. All the remaining elements of the partition wall 14 are secured to the wall structure 22 and all the remaining elements of the seat arrangement 16 are secured to the seat structure 24. Therefore, the fastening devices 26 also serve to secure the entire seat arrangement 16 and the entire partition wall 14 to each other in the assembled state M and consequently to provide the entire partition wall arrangement 20 as a mechanically secure unit.

The partition wall 14 extends in the passenger aircraft 2 in a planar manner in an extent plane 30 transversely relative to the flight direction 6 thereof. The extent plane 30 is located in FIG. 1 perpendicularly to the paper plane. The wall structure 22 contains a wall face 32 which extends along this extent plane 30 and ribs 34 which extend transversely relative to the extent plane 30 away from the wall face 32 and which are securely connected to the wall face 32. The ribs 34 provide the entire wall structure 22 with mechanical stability by extending along required load paths. In FIG. 1, the wall face 32 and ribs 34 are illustrated with different hatching. In fact, both elements are in the form of an integral wall structure 22. The ribs 34 thus have a load-path optimized extent taking into account the entire carrier structure 28. The wall structure 22 itself is thus configured in an integral manner. On the whole, the carrier structure includes in this instance 59 fastening devices 26 in the form of individual devices 36, that is to say, securing screws. The carrier structure 28 is surrounded schematically in FIG. 1 by a broken line.

The seat structure 24 is in this instance a basic structure 38 of the seat arrangement 16, in this instance a carrier frame for further components 40 of the seat arrangement 16. In this instance, a folding seat which is indicated as a rectangle and which includes an articulated folding bearing (indicated as a circle), a backrest and a headrest are provided as additional components 40. All the components 40 are in this instance secured exclusively to the basic structure 38 and consequently fitted only indirectly through them to the wall structure 22 and consequently the partition wall 14.

The partition wall arrangement 20 extends between the floor 5 and the ceiling 7 of the cabin 4. A trim 42 is a component of the partition wall 14 but does not contribute to the mechanical stability thereof and acts only as a visual trim so that the view of the ribs 34 from the passenger region 8 is concealed and a smooth visually appealing surface of the partition wall 14 towards the passenger region 8 is produced. The partition in the form of the partition wall 14 includes in this instance a thick milled plate in the form of the wall structure 22 and a metal sheet in the form of the trim 42, and both are bonded together and screwed.

In FIG. 1, the seat 18a is in use since a person (cabin attendant 12) is sitting on it.

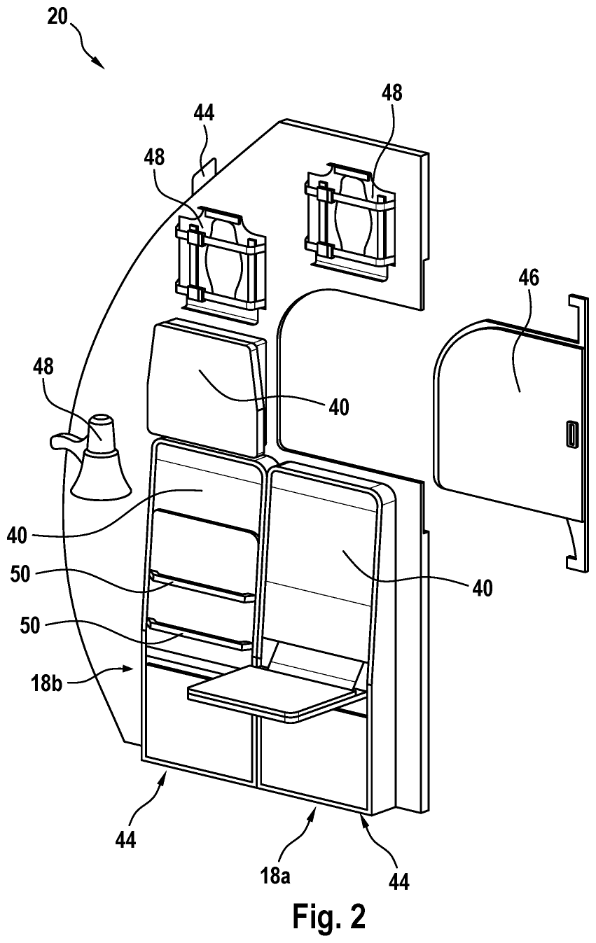

FIG. 2 shows a perspective, oblique view of the partition wall arrangement 20 of FIG. 1 from the crew region 10, in this instance an alternative variant in greater detail than in FIG. 1. It is further possible to see in this instance an upper fastening 44 which in a manner not explained in greater detail serves to secure the wall structure 22 and consequently the partition wall 14 to the primary structure (not illustrated) of the passenger aircraft 2. Other such fastenings 44 are provided at the bottom on the wall structure 22 (not visible in FIG. 2). The wall structure 22 is in this instance produced as a monolithic aluminum metal construction type. The partition wall 14 contains a wall portion 46 which can be removed, a so-called “stretcher flap” which serves in a passage region between the passenger region 8 and crew region 10 to increase a free space in the region of the partition wall 14, for example, in order to provide space for a stretcher which is intended to be transported in the flight direction 6 in the cabin 4.

In FIG. 2, both cabin crew seats 18a, b can now be seen, wherein the component 40 in the form of the seat face or the folding seat of the seat 18a is folded down, but the component of the seat 18b is folded up. The seats 18a, b are consequently in each case single CA seats. The component 40 in the form of the headrest of the seat 18a in the example is removed in order to be able to remove the wall portion 46. The headrests are in this instance in the form of head elements with a storage compartment. The components 40 in the form of the backrests constitute back elements. Below the seat faces are storage compartments which are not described in greater detail and which in this instance contain payload in the form of emergency equipment, for example, a fire extinguisher.

There are provided on the partition wall 14, in FIG. 2, further fastenings/brackets 48 for equipment (additional payload such as lifejackets, megaphone) which in this instance are not intended to be explained in greater detail. On the folding seats/seat faces of the seats 18a 18b, bumper bars 50 are provided externally at the bottom or in the folded up state.

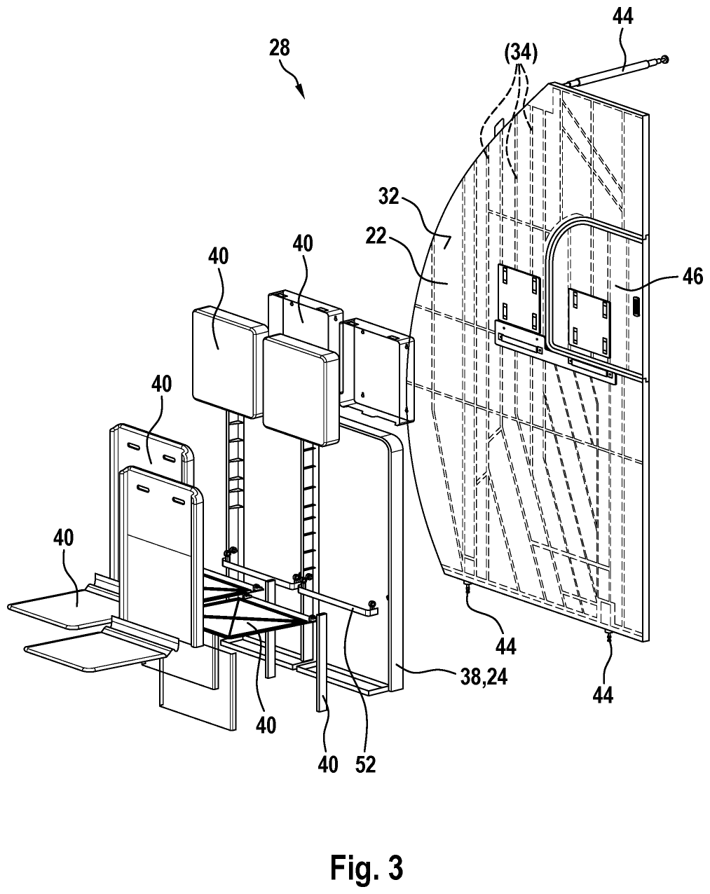

FIG. 3 shows the arrangement from FIG. 2 as an exploded view and with the wall portion 46 inserted. FIGS. 2 and 3 shows the concept A of the carrier structure 28 as mentioned above.

The ribs 34 which are actually located at the side of the wall face 32 facing away from the viewer in FIG. 3 (hence the reference numeral in parentheses) are indicated in FIG. 3 with respect to their extent. The load-path-optimized extent of the ribs 34 can be seen. It can be seen in FIG. 3 much more clearly than in FIG. 2 how the headrests are configured with a cushion and integrated storage compartment. It can accordingly be seen that a pivot apparatus 52 for both folding seats is fitted in each case directly to the basic structure 38 in the form of the seat structure 24. The seat structure 24 is in this instance in the form of a milled aluminum component in the form of a CAS frame with reinforcements. The reinforcements are in this instance produced by corresponding milling of solid material. It can also be seen how the storage compartment which is disposed below the folding seats is composed of respective profiles and covering flaps. The back and seat cushion with a seat face which can be folded in are also illustrated as components 40 of the seat arrangement 16. The folding apparatus or bearing 52 is thus secured directly only to the basic structure 38 and only by means thereof and consequently indirectly to the wall structure 22. The seat structure 24 and the wall structure 22 are in this instance in the form of a metal component. The wall structure 22 is in this instance a single integral milled component, the seat structure 24 is constructed from respective connected individual milled components.

All the components of the carrier structure 28, that is to say, wall structure 22, seat structure 24 and fastening device 26 (not illustrated) in the assembled state M are in this instance configured in a synergistically complementary manner with regard to a common technical flight strength consideration. In other words, the load-path-optimized extent of all the ribs 34 cooperate synergistically with the geometric structure of the seat structure 24 and the structural configuration thereof, in particular with regard to reinforcement regions and the securing locations therefor and the fastening device 26 used at that location in order to achieve the desired mechanical strength of the carrier structure 28.

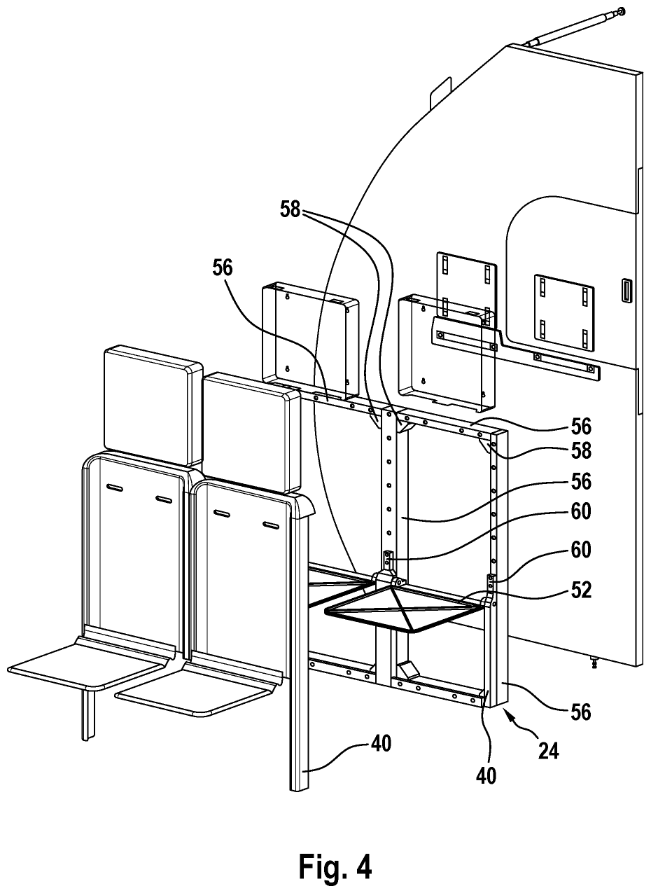

FIG. 4 shows an alternative carrier structure 28 according to concept B. In contrast to FIG. 3, in this instance the seat structure 24 is constructed from components in the form of commercially available mass-produced goods 56, that is to say, so-called standard profiles which are connected to each other by using additional mass-produced goods 58 in the form of connecting angled members. As a result of the different mechanical properties of the seat structure 24 with respect to FIG. 3, therefore, the extent of the ribs 34 with regard to the above-mentioned common technical flight strength consideration is changed with respect to FIG. 4 so that the wall structure 22 and seat structure 24 and fastening devices 26 cooperating synergistically again comply with corresponding strength requirements of the carrier structure 28 and consequently the partition wall arrangement 20. The folding bearing 52 is in this instance secured to the seat structure 24 by using an additional bracket 60. Components 40 in the form of profiles for forming the storage compartments are present again, the headrests, folding seats and seat cushions, etcetera, are configured according to FIG. 3.

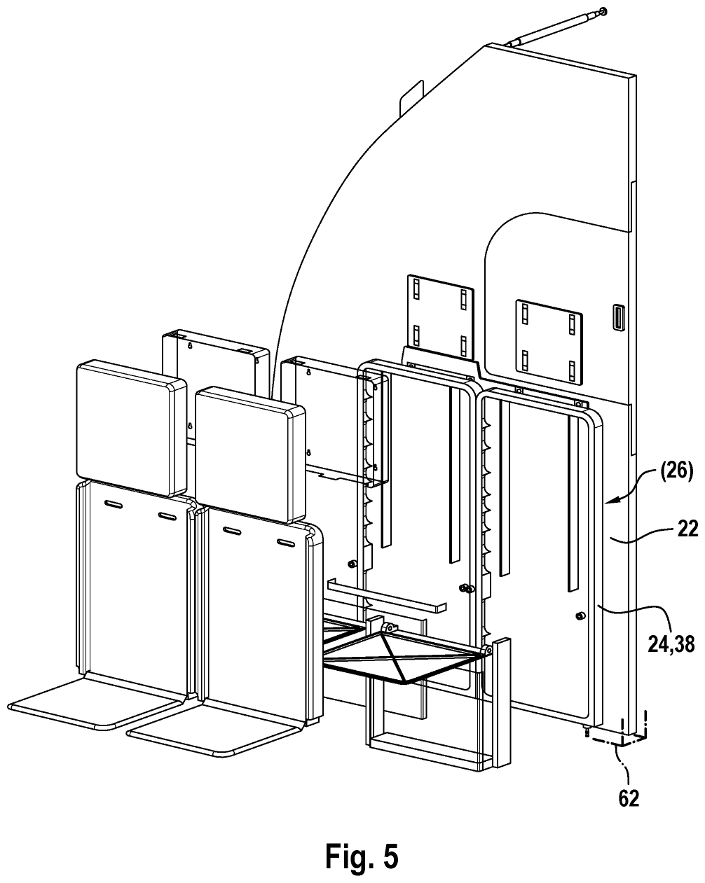

FIG. 5 shows another alternative embodiment of a partition wall arrangement 20. In this instance, not only the wall structure 22 but also the seat structure 24 are configured in an integral manner. Furthermore, the wall structure 22 and seat structure 24 are also configured integrally with each other, the entire carrier structure 28 thus forms a single integral milled component made of aluminum. Fastening devices 26 are in this instance contained implicitly or without a specific type (hence reference numeral in parentheses) in the form of the generic (milling out from a common base plate) materially engaging connection of the wall structure 22 and seat structure 24. According to FIG. 5, therefore, the aluminum CAS frame in the form of the basic structure 38 or seat structure 24 is produced as an aluminum milled component together with the entire wall structure 22. Also in this instance, as according to FIG. 3, the folding bearing 52 is secured directly to the basic structure 38. Otherwise there are no significant differences with regard to the concepts A and B.

Therefore, while with all three concepts A to C the wall structure 22 is produced as a milled component by milling out a solid material plate 62, in the concept C the seat structure 24 and consequently the entire carrier structure 28 is produced as an integral milled component by milling out a solid material plate 62. The solid material plate 62 is illustrated schematically in FIG. 5 with dashed lines.

In all the concepts A to C, the entire carrier structure 28 is subjected in the assembled state M to a load path optimization. This is carried out virtually by modelling the seat structure 24, wall structure 22 and fastening device 26 and corresponding CAD strength considerations, which are not explained in greater detail herein, by using iterative reconstruction of the individual components.

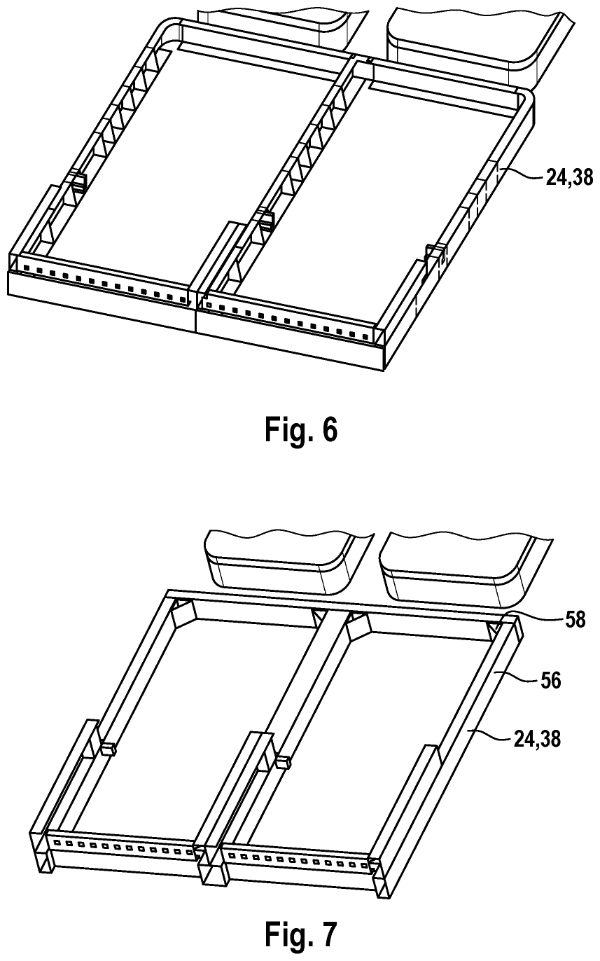

FIG. 6 shows again the seat structure 24 according to concept A, including individual aluminum milled components, in detail, and in addition (partially) the headrests which do not belong to the seat structure 24 and other components 40 in the form of the storage compartment frame which are located below the folding seats in the assembled state.

FIG. 7 shows the seat structure 24 according to concept B composed of the mass-produced goods 56 (standard profiles) and 58 (connecting angled members) 58 and corresponding components 40 according to FIG. 6.

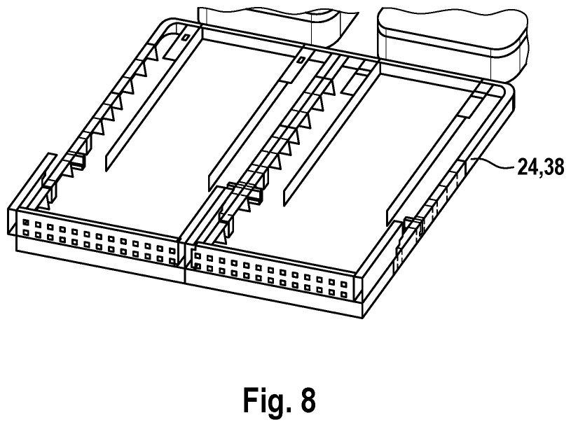

FIG. 8 also shows for concept C the seat structure 24 as part of the integrally milled solid material plate 62, but for the sake of clarity without the wall structure 22 which is configured integrally therewith. Other components 40, such as headrests and storage compartments, are also illustrated accordingly in this instance.

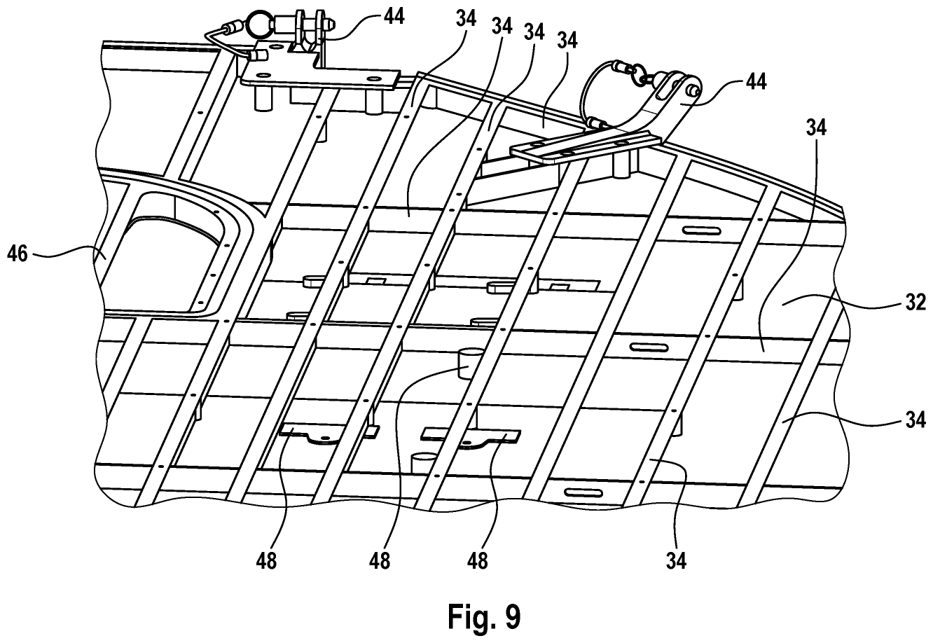

FIG. 9 shows a view of the wall structure 22 from the passenger region 8. The trim 42 is omitted in this instance. It is possible to see the fastenings 44 for the primary structure of the passenger aircraft 2, the wall face 32 and ribs 34 which are formed integrally thereon and components of the brackets 48 from FIG. 2 which extend through the wall face 32 in the direction towards the passenger region 8.

The following is a summary list of reference numerals and the corresponding structure used in the above description of the invention,

### LIST OF REFERENCE NUMERALS

2 Passenger aircraft
4 Cabin
5 Floor
6 Flight direction
7 Ceiling
8 Passenger region
10 Crew region
12 Cabin crew
14 Partition wall
16 Seat arrangement
18a,b Seat (cabin crew)
20 Partition wall arrangement
22 Wall structure
24 Seat structure
26 Fastening device
28 Carrier structure
30 Extent plane
32 Wall face
34 Ribs
36 Individual device (fastening device)
38 Basic structure
40 Component (seat arrangement)
42 Trim (partition wall)
44 Fastening
46 Wall portion (partition wall)
48 Bracket
50 Bumper bar
52 Folding bearing
56 Mass-produced goods (standard profile)
58 Mass-produced goods (connecting angled member)
60 Bracket
62 Solid material plate
M Assembled state

1. In a partition wall arrangement for a cabin of a passenger aircraft including a partition wall, a seat arrangement secured to the partition wall in an assembled state and at least one cabin attendant seat, a carrier structure for the partition wall arrangement, comprising:
a mechanically load-bearing wall structure for the partition wall;
a mechanically load-bearing seat structure for the seat arrangement; and
at least one conventional fastening device configured to secure said wall structure and said seat structure to each other in a conventional manner in the assembled state.

2. The carrier structure according to claim 1, wherein said wall structure, said seat structure and said at least one fastening device are configured to be synergistically mutually complementary in the assembled state with regard to a common technical flight strength consideration.

3. The carrier structure according to claim 1, wherein said wall structure contains ribs and a wall face extending along an extent plane of the partition wall, said ribs extending transversely relative to and in a direction away from said extent plane and being securely connected to said wall face.

4. The carrier structure according to claim 1, wherein at least one of said wall structure or said seat structure is configured in one piece.

5. The carrier structure according to claim 1, wherein at least a portion of said wall structure is configured in one piece with at least a portion of said seat structure.

6. The carrier structure according to claim 5, wherein the carrier structure is configured entirely in one piece.

7. The carrier structure according to claim 1, wherein at least one of said wall structure or said seat structure is a metal component or contains a metal component at least as a main component.

8. The carrier structure according to claim 1, wherein at least one of said wall structure or said seat structure is a milled component or contains a milled component at least as a main component.

9. The carrier structure according to claim 1, wherein said seat structure includes at least one component being commercially available mass-produced goods or contains at least one component being commercially available mass-produced goods at least as a main component.

10. The carrier structure according to claim 1, wherein said at least one fastening device includers at least twenty fastening devices being individual devices.

11. The carrier structure according to claim 1, wherein said seat structure is a basic structure of the seat arrangement constructed only to receive at least one additional component of the seat arrangement.

12. A partition wall arrangement for a cabin of a passenger aircraft, the partition wall arrangement comprising:
a carrier structure according to claim 1;
the partition wall containing said wall structure;
the seat arrangement secured to said partition wall, the seat arrangement containing said seat structure;
the at least one cabin attendant seat; and
said at least one fastening device securing the seat structure to said wall structure.

13. A method for producing a carrier structure, the method comprising:
producing the carrier structure according to claim 1 by producing at least one of the wall structure or said seat structure or at least a main component of the wall structure or said seat structure as a milled component by milling out a solid material plate.

14. A method for producing a partition wall arrangement, the method comprising:
producing the partition wall arrangement according to claim 12 by producing at least one of the wall structure or said seat structure or at least a main component of the wall structure or said seat structure as a milled component by milling out a solid material plate.

15. The method according to claim 13, which further comprises configuring at least a portion of said wall structure together with at least a portion of said seat structure integrally with each other, by producing at least a portion of said wall structure and at least a portion of said seat structure as an integral milled component by milling out the solid material plate.

16. The method according to claim 14, which further comprises configuring at least a portion of said wall structure together with at least a portion of said seat structure integrally with each other, by producing at least a portion of said wall structure and at least a portion of said seat structure as an integral milled component by milling out the solid material plate.

17. A design method for a carrier structure, the design method comprising:
producing the carrier structure according to claim 1 by entirely subjecting the carrier structure in an assembled state to a load path optimization.

18. A design method for a partition wall arrangement, the design method comprising:
producing the partition wall arrangement according to claim 12 by entirely subjecting the carrier structure in an assembled state to a load path optimization.
